(19) United States
(12) Patent Application Publication
(10) Pub. No.: US 2004/0150727 A1
(43) Pub. Date: Aug. 5, 2004

(54) Electronic device user interface for selecting persistent settings

(76) Inventor: Amy E. Battles, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/355,421

(22) Filed: Jan. 31, 2003

(51) Int. Cl. H04N 5/76

(52) U.S. Cl. 348/231.99

(57) ABSTRACT

A user interface for an electronic device allows a user to make device settings persist after the device is turned off and then on again, or through other changes in operating mode. The user interface selection for making a setting persistent is presented to the user at the same time as the selection for the setting itself. The user interface may optionally be implemented using a control that enables horizontal and vertical scrolling, such as a four-way rocker switch or its equivalent.

### FIELD OF THE INVENTION

The present invention relates generally to user interfaces.

### BACKGROUND OF THE INVENTION

A digital camera serves as an example of an electronic device with a user interface. A typical digital camera includes a display, which is often a liquid crystal display (LCD). This display may be used for displaying digital photographs, and also for presenting information to a user of the camera. Using the display in conjunction with one or more user-operated controls provides a user interface by which a user of the camera can control the operation of the camera.

A typical camera may have several user-specified settings that configure its operation. For example, the camera may have several light metering modes. A “spot” mode may use only a small portion of a scene near the center of the camera's field of view to evaluate the proper exposure for a photograph. An “average” mode may use the entire field of view of the camera to evaluate exposure. And a “center-weighted” mode may consider the entire field of view, but weight an area in the center of the field of view more heavily than peripheral portions of the scene in the exposure determination. A photographer may wish to choose a particular metering mode in a particular photographic situation. For example, spot metering is often useful in close-up and portrait photography, while average metering is often useful in landscape photography.

Users of digital cameras frequently wish to turn their cameras off during idle periods between photographs in order to conserve battery power. However, some cameras return the photographic settings, such as the metering mode, to default values after they have been turned off and then on again. Turning the camera off and on is often called a power cycle, and having camera setting change through a power cycle can be very inconvenient for a photographer who wishes to take several photographs of a scene with non-default camera settings. For example, during a portrait session, the photographer may be using a camera that defaults to average metering. The photographer may set the camera for spot metering, take one or more photographs, and then turn the camera off while setting up another pose. Upon turning the camera back on, the photographer must once again set the camera to spot metering. This step is easy to forget, and takes time that could be used more effectively, especially if there are several settings that need to be reentered.

Events other than a power cycle can cause camera settings to change as well. For example, a camera may have a self-timer that allows a delay between the pressing of the shutter release button and the taking of a photograph. This feature is often used by photographers who want to include themselves in a picture. Often, the self-timer feature may automatically cancel after each photograph, returning the camera to its usual operating mode. A photographer who wishes to take several photographs with the self-timer may find it inconvenient to have to re-enable the feature before every photograph.

Some cameras allow settings to be made persistent, or “sticky.” That is, the camera stores their state in non-volatile memory, and returns those settings to the same configuration on power-up as they were in at the time it was turned off. However, the techniques available for making camera settings persistent are themselves cumbersome and error-prone. For example, some cameras require that they be put into a special mode in order for settings to persist through a power cycle. Other cameras have a special menu that allows the user to specify which settings should be persistent.

What is needed is a simple, robust system for selecting persistent settings in an electronic device.

### SUMMARY OF THE INVENTION

A user interface for an electronic device allows a user to make device settings persist after the device is turned off and then on again, or through other changes in operating mode. The user interface selection for making a setting persistent is presented to the user at the same time as the selection for the setting itself. The user interface may optionally be implemented using a control that enables horizontal and vertical scrolling, such as a four-way rocker switch or its equivalent.

### BRIEF DESCRIPTION OF THE DRAWINGS

FIG. 1 depicts a rear perspective view of a typical digital camera.

FIG. 2 depicts a portion of a user interface in accordance with an example embodiment of the invention.

FIG. 3 depicts a portion of a user interface in accordance with a second example embodiment of the invention.

FIGS. 4A and 4B depict a third user interface in accordance with another example embodiment of the invention.

FIG. 5 depicts a block diagram of a digital camera.

### DETAILED DESCRIPTION OF THE PREFERRED EMBODIMENT

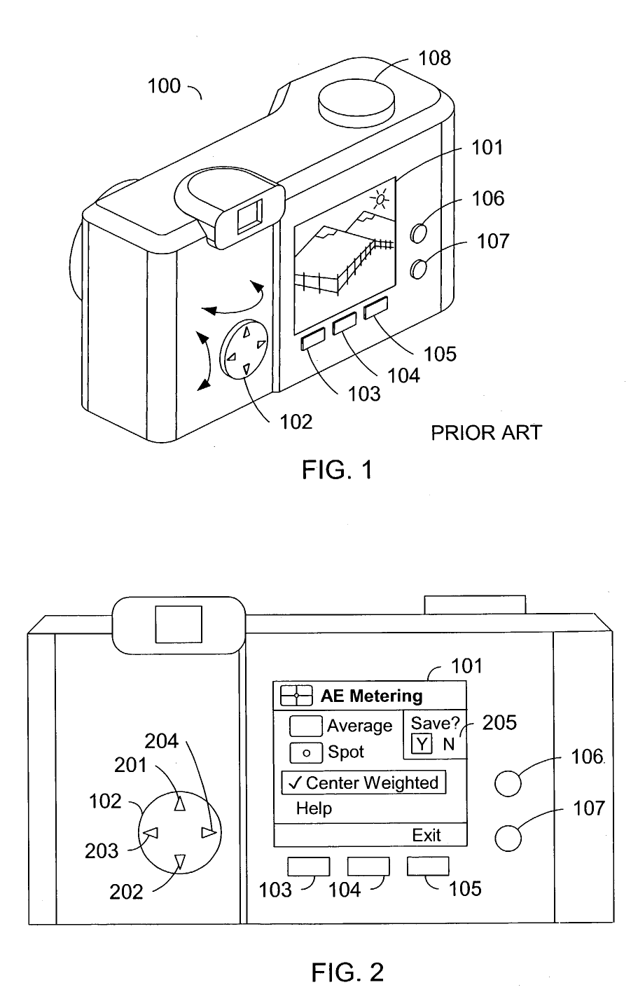

FIG. 1 depicts a rear perspective view of a typical digital camera 100. Display 101 may be used as shown for displaying photographs, and may be a liquid crystal display (LCD). Display 101 may also be used for presenting other information to the user of the camera. For example, display 101 may be used to present menus or selections for controlling the camera's operation.

Various controls 102-108 are available for user input. The controls 102-108 may comprise buttons, dials, switches, touchpads, or other devices for communicating the user's intent to the camera. The particular way that the camera presents information on display 101 and receives instruction through controls 102-108 is often called the camera's user interface. The term user interface may also encompass the display 101 and controls 102-108 themselves. Typically, a microprocessor, digital signal processor, or other logic within the camera coordinates the display of information and the receiving of input from the various user controls. The microprocessor or other logic may execute a stored program that determines its sequence of operations.

Control 102 is a rocker switch with two axes of motion, also called a four-way rocker switch. Pressing the switch at its periphery engages one of four electrical contacts, corresponding to the four directional indicators 201-204 on control 102. Because the contacts on control 102 are placed at four equally spaced locations, it is convenient to think of control 102 as having a vertical control direction and a horizontal control direction corresponding to the two axes of motion. Menus and selections may be displayed on display 101 in such a way as to make navigation of them naturally correspond to the vertical and horizontal control directions of control 102.

For example, FIG. 2 depicts a portion of a camera user interface for selecting a light metering mode in accordance with an example embodiment of the invention. Display 101 shows a menu of choices that the user may navigate and select. For example, by pressing control 102 at location 201 or 202, the user may navigate the list of modes vertically, scrolling up or down respectively through the list. The camera may highlight the currently selected mode choice.

On the same display is an additional menu item 205 for selecting whether the particular mode setting should persist through a camera power cycle or other change in operating mode. In the example embodiment shown in FIG. 2, this additional item is labeled “Save?” and gives the user a choice of “Y” for yes and “N” for no. The user may press control 102 at location 203 or 204 to navigate these choices horizontally, scrolling left or right respectively. Once the mode and persistence preference settings are chosen, the user may press button 105 to exit this particular menu.

The function of a four-way rocker switch may be accomplished by four separate buttons or other controls arranged in a similar pattern as direction indicators 201-204 on control 102. The horizontal and vertical directions of operation may also be accomplished by two separate two-way rocker switches.

Other descriptions of the persistence selection may be used within the scope of the appended claims. For example, instead of using the word “Save?” to ask the user whether the mode setting should be persistent, the camera could use another word or phrase, such as “Persist?”, “Sticky?”, or some other word or phrase.

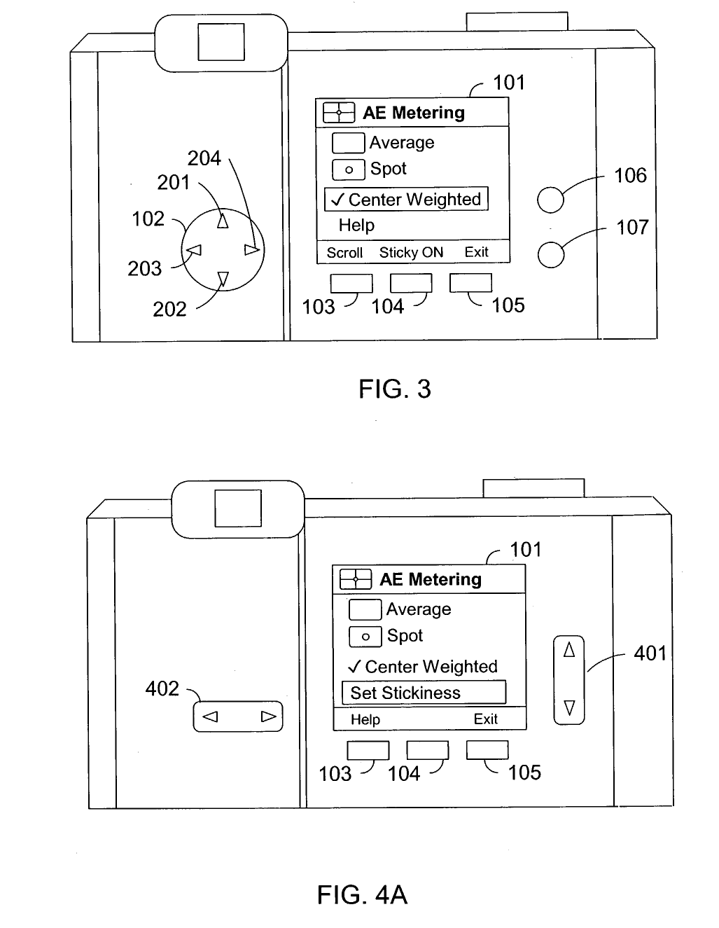

In addition, other example embodiments may be constructed. For example, rather than use control 102 for navigation of the menu, buttons 103 and 104 could be used. A second example embodiment using this scheme is depicted in FIG. 3. In this second example embodiment, button 103 is used to select a choice from the list of modes, while button 104 toggles between persistence preferences. Pressing button 105 exits the menu. One of skill in the art will be able to envision other example embodiments within the scope of the appended claims, using other combinations of user controls and display presentations.

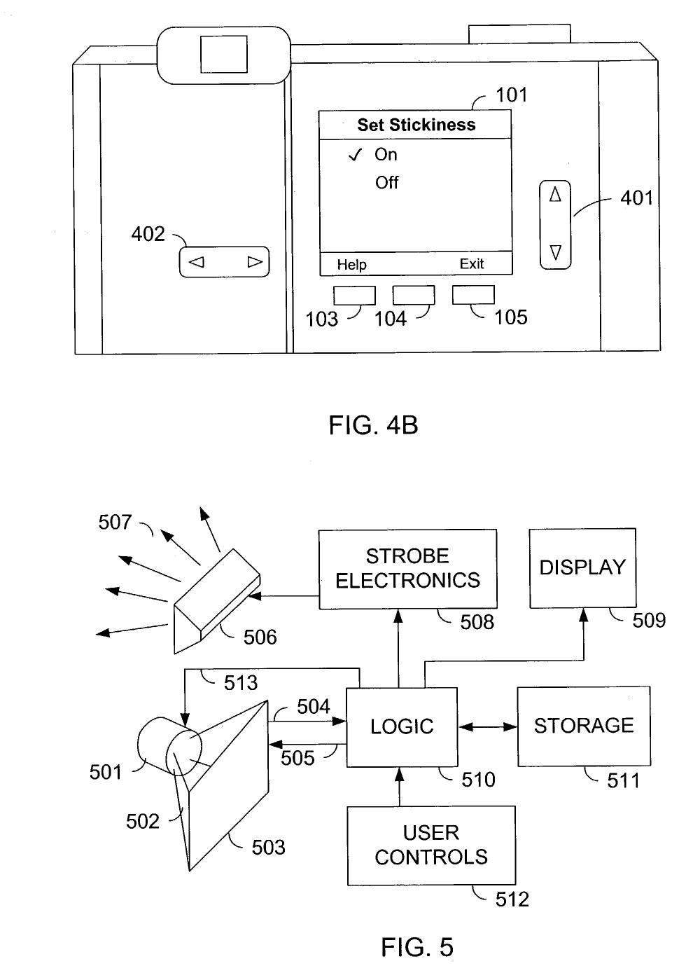

FIGS. 4A and 4B depict a third user interface in accordance with another example embodiment of the invention. In this example embodiment, a selection for setting the persistence of the setting is presented as another item in the menu of setting choices. The user may navigate the menu of setting choices using control 401, which is a two-way rocker switch. When the “Set Stickiness” setting choice is selected, the user may proceed to a submenu presented on display 101. Control 402, another two-way rocker switch, may be used to proceed to the submenu. The submenu is shown in FIG. 4B, and allows the user to select whether stickiness or persistence is to be turned on or off. Of course, other words or phrases may be used to indicate the operation.

The light metering mode described above provides one example of many camera settings that may be amenable to adjustment in a user interface according to the invention. Others include the camera's flash or strobe mode, the camera's ISO speed rating, the camera's white balance processing used to adjust the color of photographs taken in varying light conditions, and the camera's exposure mode. Typical exposure modes include shutter priority, aperture priority, portrait, landscape, and action programs.

FIG. 5 depicts a block diagram of a digital camera that may embody the invention. A lens 501 gathers light from a scene (not shown). The gathered light is redirected 502 to form an image of the scene on a sensor 503. The sensor may be an array of CCD elements, CMOS sensors, or the like. The operation of the lens may be controlled by control signals 513 from a logic unit 510, which may contain a microprocessor system. Likewise the operation of the sensor may be controlled by control signals 505 from logic unit 510. Image information signals 504 flow from the sensor to the logic unit 510. A flash, or strobe 506 may be utilized to supply additional light 507 to the scene. The strobe is operated by the strobe electronics 508, which in turn are controlled by the logic unit 510. The camera may comprise a display 509 on which image data may be shown. The camera may comprise a storage unit 511 for storage and recall of image data, as well as data interchange with other devices (not shown). Storage unit 511 may comprise both volatile and non-volatile forms of data storage. The user of the camera may operate various user controls 512 in order to affect the operation of the camera.

In addition to digital cameras, other electronic devices may have settings that are adjusted using a user interface in accordance with the invention. For example, some cellular telephone users may wish for the ringing volume of their phones to persist through a power cycle, while others may not. A factory manager who receives most of his calls on a noisy factory floor may wish his phone to always ring loudly. An executive who normally receives calls in a quiet office environment, but is expecting a particular call at a noisy sporting event, may wish to set his phone's ring volume to a loud setting temporarily, but not have the setting persist after the phone is turned off so as not to risk a loud and disruptive ring when he returns to the office at a later time. A phone embodying a user interface in accordance with the invention permits both phone users to quickly and conveniently set their phones to perform as desired, with little chance of error.

A user interface embodying the invention may also be used in other portable electronic devices such as a person digital assistant (PDA). A PDA is a handheld device that allows a user to store, recall, and organize information.

Further, user interfaces embodying the invention are not limited in application to electronic devices that are portable. For example, a computer could employ a user interface embodying the invention. Typically, a computer would present choices to a user on a display screen that may be a cathode ray tube or a liquid crystal display. The user control used to give input to the computer may be a keyboard, mouse, trackball, tablet, or other input device.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A electronic device user interface, comprising:
a) a display;
b) a menu of choices for a setting and a menu for selecting whether a setting choice is to persist through a change in operating mode, the menu of choices for the setting and the menu for indicating whether the setting choice is to persist being shown on the display simultaneously.

2. The electronic device user interface of claim 1 wherein the change in operating mode is a power cycle.

3. The electronic device user interface of claim 1, further comprising a user control for selecting from the menu of choices for a setting.

4. The electronic device user interface of claim 3, further comprising a user control for choosing a persistence preference from the menu for indicating whether the setting choice is to persist through a change in operating mode.

5. The electronic device user interface of claim 4 wherein the user control for selecting from the menu of choices for a setting and the user control for choosing a persistence preference from the menu for indicating whether the setting choice is to persist through a change in operating mode are operated by motions in orthogonal directions.

6. The electronic device user interface of claim 4 wherein the user control for selecting from the menu of choices for a setting and the user control for choosing a persistence preference from the menu for indicating whether the setting choice is to persist through a change in operating mode are the two axes of motion of a four-way rocker switch.

7. An electronic device comprising the electronic device user interface of claim 1.

8. The electronic device of claim 7 wherein the electronic device is a camera.

9. The electronic device of claim 8 wherein the camera is a digital camera.

10. The electronic device of claim 7 wherein the electronic device is a cellular telephone.

11. The electronic device of claim 7 wherein the electronic device is a personal digital assistant.

12. The electronic device of claim 7 wherein the electronic device is a computer.

13. A method of interacting with a user of an electronic device, comprising:
a) simultaneously displaying a menu of choices for a setting and a menu for selecting whether a setting choice is to persist through a change in operating mode;
b) receiving input from a user control that selects from the menu of choices for a setting; and
c) recieving input from a user control that chooses a persistence preference from the menu for indicating whether the setting choice is to persist through a change in operating mode.

14. An electronic device, comprising:
a) means for simultaneously displaying a menu of choices for a setting and a menu for selecting whether a setting choice is to persist through a change in operating mode;
b) means for selecting from the menu of choices for a setting; and
c) means for choosing a persistence preference from the menu for indicating whether the setting choice is to persist through a change in operation mode.

15. The electronic device of claim 14 wherein the change in operating mode is a power cycle.

16. A digital camera, comprising:
a) a display simultaneously presenting a list of setting choices and a menu item for indicating whether a setting choice is to be persistent through a change in operating mode;
b) a first user control that selects from the list of setting choices;
c) a second user control that specifies whether a currently selected setting choice is to be persistent through a change in operating mode; and
d) logic that receives input from the first and second user controls, causes the list of setting choices and the menu item for indicating whether a setting choice is to be persistent through a change in operating mode to be shown on the display, and indicates in response to the user controls which setting choice is the currently selected setting choice and whether the currently selected setting choice is to be persistent through a change in operating mode.

16. The digital camera of claim 15, further comprising a non-volatile memory, and wherein the microprocessor stores setting choices that are persistent through a change in operating mode in the non-volatile memory.

17. The digital camera of claim 15 wherein the change in operating mode is a power cycle.

18. An electronic device user interface, comprising:
a) a display;
b) a menu of choices for a setting, including a choice indicating that it can be used for specifying whether a setting choice is to persist through a change in operating mode; and
c) a submenu, entered from the first menu, for accomplishing the specification of whether the setting choice is to persist through a change in operating mode.

19. The electronic device user interface of claim 18 wherein the change in operating mode is a power cycle.
